(19) United States
(12) Patent Application Publication
(10) Pub. No.: US 2023/0280964 A1
(43) Pub. Date: Sep. 7, 2023

(54) Systems and Methods for Delivering Audio Files

(71) Applicant: Huso, Inc., Franklin, TN (US)

(72) Inventors: Susan E. Whitehawk, Franklin, TN (US); William S. Flanagan, III, Asheville, NC (US); Alan Dean Michel, Fishers, TN (US); Broderick Donald Robertson, Fishers, TN (US)

(21) Appl. No.: 18/093,642

(22) Filed: Jan. 5, 2023

Related U.S. Application Data
(60) Provisional application No. 63/315,929, filed on Mar. 2, 2022.

(51) Int. Cl. G06F 3/16

(52) U.S. Cl. CPC G06F 3/16

(57) ABSTRACT

A method is described herein comprising one or more applications running on at least one processor of a mobile device for providing receiving a mono audio file, receiving a stereo audio file, applying digital signal processing to the mono audio file, wherein the signal processing converts the mono audio file into a processed format suitable for transmission using a first communications protocols, synchronizing transmission of the mono audio file and the stereo audio file, transmitting the mono audio file to at least one remote sensor in the processed format using the first communications protocol, and transmitting the stereo audio file through an audio output of the mobile device using a second communications protocol.

### RELATED APPLICATIONS

This application claims priority to U.S. Application No. 63/315,929, filed Mar. 2, 2022.

### TECHNICAL FIELD

The disclosure herein involves management and delivery of audio files using an application running on an operating system of a mobile device.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 shows a mobile device transmitting a mono audio file to multiple sensors, under an embodiment.

FIG. 2 shows a mobile device transmitting a stereo audio file to a peripheral device, under an embodiment.

FIG. 3 shows a mobile device transmitting a mono audio file to multiple sensors and a stereo audio file to a peripheral device, under an embodiment.

FIG. 4 shows a mobile device transmitting a mono audio file to multiple sensors and a stereo audio file to a peripheral device, under an embodiment.

FIG. 5 shows a method for transmitting a mono audio file to multiple sensors and a stereo audio file to a peripheral device, under an embodiment.

### DETAILED DESCRIPTION

The HUSO iOS Mobile Application (App) implements a novel approach to playback audio as mono haptic feedback to multiple HUSO Bluetooth LE Peripherals (Sensors) simultaneously while maintaining playback of distinct but synchronized stereo audio data on the mobile device. The iOS mobile device continues to play audio out of its internal speakers or operating system supported audio outputs such as AirPlay or Bluetooth Classic headphones.

Traditionally playback to multiple Bluetooth peripherals such as wireless earbuds occurs over Bluetooth Classic (BR/EDR) protocols and via connection to a single peripheral which relays the audio signal to the secondary peripherals over a peer-to-peer Bluetooth Classic connection between the peripherals. Bluetooth Classic radio, also referred to as Bluetooth Basic Rate/Enhanced Data Rate (BR/EDR), is a low power radio that streams data over 79 channels in the 2.4 GHz unlicensed industrial, scientific, and medical (ISM) frequency band. The HUSO application provides audio (under the conditions described herein) to Haptic sensors which attach to a user. The Haptic sensor provides tactile vibration in a more direct fashion than a “standard” moving coil loudspeaker/transducer by being designed for direct contact with the skin surface while minimizing the amount of direct audio that is produced from a diaphragm on a typical acoustic transducer such as a loudspeaker.

The use of a Haptic transducer helps prevent disturbing others nearby while providing the appropriate tactile sensation for the HUSO stimulation. This transducer is driven by an efficient Class D amplifier with a 500 Hz bandlimited signal suitable for the content of the audio being presented by the headphones to the user. The 500 Hz bandwidth signal for the class D amplifier is using 16 Bit 1 Ksample/second 16 bit audio received from the application over a BLE serial link. Suitable buffering of the samples are provided to prevent loss of continuous signal if there are brief interruptions in the BLE signal. The 1 Khz data can represent any arbitrary 500 Hz band limited signal according to the Nyquist sampling theorem. In order that the spectral images of the 500 Hz audio centered around integer multiples of the 1 Khz sample rate are also not audible from the transducer, a polyphase finite impulse response interpolation filter interpolates the 15 untransmitted values of the 500 Hz band limited signal between the 1 Ksample/second signals to derive a 16 Khz signal, still having just the 500 Hz bandlimited content, but with the images around integer multiples of the sample rate removed.

A general workflow of the HUSO application begins with a user downloading the application itself When the user launches the application, the user is presented with introductory messages about the application features. The user then configures HUSO sensors to operate with the mobile application. Sensor Configuration

The user powers on the sensor. The mobile application discovers the sensor via BLE advertisement and identifies the sensor via the Manufacturers Advertising Data Types (AD Type). The mobile application discovers required BLE Services and Characteristics required for operation. Such a service, used in this case, is Nordic UART Service (NUS). The mobile application then caches this device as a user device so the user does not have to set it up again.

The user then selects a free or subscription based audio program to playback. When audio program playback begins, if one or more sensors are connected, a mono audio file plays back to the sensors (haptic transducers) while the stereo file plays back over the mobile device's current audio output device (phone speakers, wired headphones, wireless headphones). The user is able to subscribe on an ongoing basis to receive access to premium audio programs.

The application downloads a stereo audio file encoded in MP3 format intended for playback from the mobile device via internal speakers or supported outputs

The application downloads an entirely separate and distinct mono audio file encoded in MP3 format intended for playback to HUSO Sensors

The application performs digital signal processing (DSP) on the mono audio to make the audio data appropriate for transmission over Bluetooth LE NUS GATT Service Characteristics and playback as haptic feedback. The application uses AudioKit for some of the DSP steps as described below. AudioKit is a third party open source library. (See https://audiokit.io).

The DSP comprises the following steps:
Low pass filtering of audio—The application uses AudioKit.LowPassFilter (which is an abstraction of Apple AudioToolbox LowPassFilter) configured to 500 Hz.
Resampling and re-encoding of audio from 44.1 kHz 192 kbps MP3 to IkHz 16 bit PCM
The application uses Apple AVAudioConverter to perform the conversion of audio to this format.
The application frames the audio data and transmits the processed audio data to the Sensors—The application streams audio data in variable packet sizes to the BLE Nordic UART Service. The packet size is determined by the current BLE MTU (Maximum Transmission Unit) which is determined by the mobile device's physical hardware and operating system. The data is not framed with a header or CRC of any kind. Pure audio data is streamed in real time as it is played back and processed from the mobile device.
The application takes into account the system latency which includes Bluetooth LE data transmission time and Sensor data buffering in order to synchronize the playback of the stereo audio data on the mobile device to the mono audio data on the Sensor device. The application uses a static delay value of −250 ms based average measured BLE transmission, DSP delay of <1 ms, and on the total buffer size of the sensor. This delay of 250 ms insures that the BLE sensor audio and the audio being played through the headset directly or over BlueTooth Classic is synchronized in time.
Each sensor buffers the received mono audio data. A 512 sample circular ring buffer is used. 16 bit, 1 Ksample/second data received from the BLE radio link fills the buffer, and when the buffer is half full, the process of playing audio from the buffer is started. This buffering provides two functions. First, if data did not arrive in the expected time of 100 ms per 100 samples, then data from the buffer can cover the time until data does arrive up to two missing sets of 100 samples. Second, if there are small differences in the sample rate clocks between the sensor arm band SOC (System on a Chip) that is playing the data, and the IOS device (iPhone, ipad, etc) that is sending the data, the buffering makes sure that small differences in clocks, for example using a 50 ppm clock precision, will not affect the signal quality. At 100 ppm difference in clock frequency, for example IOS device is +50 ppm, and the wristband is −50 ppm, it would take 10,000*256 ms or 2560 seconds (42 minutes, 40 seconds) before the 100 ppm clock differences caused the buffering to run empty, or for the buffer to fill completely and wrap around. None of the media files used are greater than this length. In the worst case scenario (−50 PPM on one system and +50 PPM on another), there would be a slight discontinuity in the signal approximately every 43 minutes. This scenario requiring the dropping of 512 samples or re-use of 512 samples would not be noticeable using a haptic device.
The Sensor up converts received mono audio data to 16 kHz 16 bit PCM data for playback. The 1 Khz data can represent any arbitrary 500 Hz band limited signal according to the Nyquist sampling theorem. However, in order that the spectral images of the 500 Hz audio centered around integer multiples of the 1 Khz sample rate (2 Khz, 3 Khz 4 Khz, 5 Khz, 6 Khz, 7 Khz, 8 Khz, etc) are also not audible from the transducer, a polyphase finite impulse response interpolation filter interpolates the missing 15 values of the 500 Hz band limited signal between the 1 Ksample/second signals to derive a 16 Khz signal, still having just the 500 Hz bandlimited signal content, but with the images around multiples of the sample rate removed. This polyphase filter uses a 16 Khz sample rate, and has a bandpass of 470 Hz and a stop band of 530 Hz to 8 Khz.
The Sensor plays back the processed audio data to haptic transducers. The polyphase filter output of 16 Khz 16 bit PCM data is sent from the BLE SOC chip to a digital class D amplifier IC using I2S (Inter-Integrated circuit Sound) three wire protocol. The Class D amplifier converts this to a high frequency (several hundred Khz) PWM (pulse width modulated) signal who's low frequency content is the desired electrical signal for the Haptic Transducer. The Haptic Transducer, being an inductive load, does not respond to the high frequency content of the class D amplifier output, and therefore only absorbs low frequency electrical energy from the baseband 500 Hz bandwidth signal. These class D amplifiers provide high efficiency, typically >90%, compared to analog amplifiers of various types, and are often used in battery powered or modern high efficiency digital audio systems. Alternatively, Analog amplifiers typically consume >50% of the electrical energy as heat, rather than delivering the energy to the load. This reduces both battery life and maximum allowable signal strength from a given battery voltage.

The mono audio file plays to ALL connected HUSO sensors and the stereo file plays to the selected mobile device audio output. The application is transmitting data to multiple independent BLE sensors each with an independent connection to the mobile phone. This data is being communicated over NUS using BLE GATT protocol.

The mobile operating system iOS allows multiple Bluetooth Classic (BR/EDR) peripheral connections simultaneously. iOS allows limited interaction with a Bluetooth Classic peripheral via a third party app such as HUSO. iOS allows routing of audio output to only a single Audio output at a time. The audio output is selectable by the user in the operating system. Example user selectable outputs include iOS device speakers, wired headphones, bluetooth classic device, AirPlay, etc. When playing to a Bluetooth Classic peripheral such as AirPods or TWS Earbuds, one of the peripherals acts as a primary and the other acts as a secondary. The audio is transmitted over Bluetooth Classic via a profile such as A2DP to the primary and the primary relays the audio to the secondary, i.e. the iOS device is only connected to one of the peripherals. This is the primary limitation of using Bluetooth Classic profiles for audio playback to HUSO sensors. If we use Bluetooth Classic we can only play audio to the sensors OR one of the other audio outputs listed above but not both simultaneously.

The mobile operating system iOS allows multiple Bluetooth Low Energy (BLE) peripheral connections simultaneously. BLE is historically intended for low power devices such as sensors running on watch batteries (e.g. Tile Tracker) but has rapidly become a preferred method of peer-to-peer communication with all types of peripherals & power sources. iOS allows interaction with multiple BLE peripherals simultaneously via a third party app such as HUSO and independent of audio output. This is the approach are used to overcome the limitations with Bluetooth Classic audio playback.

The HUSO application connects to multiple independent BLE sensors simultaneously. The HUSO application performs DSP of a Mono audio track in real time to make the data size appropriate for transmission over BLE. The HUSO application transmits the processed Mono sensor audio to each connected BLE sensor using BLE GATT Service Characteristics. The sensor buffers received audio and performs DSP of the received audio to improve it for playback via the haptic transducer. The HUSO app plays back Stereo audio (intended for listening) via user selected audio output which may be a Bluetooth Classic peripheral, wired headphone, or any other audio output listed above in iOS Use Cases. The HUSO app synchronizes playback of the stereo audio and mono audio by delaying the stereo audio playback by −250 ms to account for the latency of transmitting the mono audio data to the sensors and the sensors buffering latency.

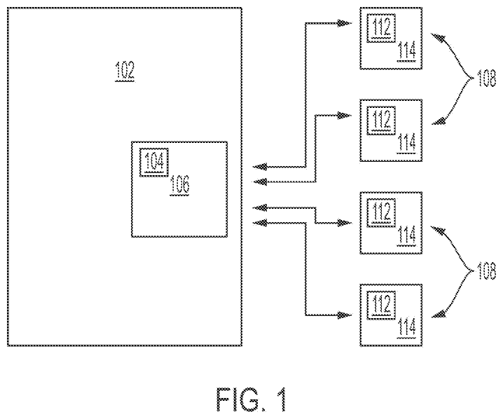

FIG. 1 shows a mobile device, under an embodiment. The mobile device 102 includes one or more processors 106. One or more applications 104 run on the one or more processors 106, wherein the one or more processors transmit mono audio files to remote sensors 108. The sensors may comprise haptic sensors under an embodiment. FIG. 1 shows the mobile device communicatively coupled with remote sensors. Each sensor 108 includes one or more applications 112 running on one or more processors 114. The mobile device transmits a processed mono audio file to multiple sensors (including haptic transducers) using Bluetooth Low Energy protocols. The sensors buffer, process, and play the mono audio file.

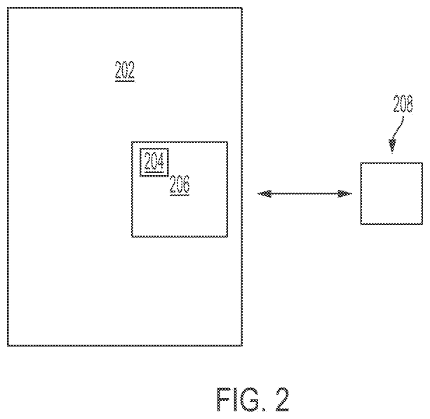

FIG. 2 shows a mobile device, under an embodiment. The mobile device 202 includes one or more processors 206. One or more applications 204 run on the one or more processors 206, wherein the one or more processors transmit stereo audio files to a peripheral device 208 through an audio output of the mobile device. FIG. 2 shows the mobile device communicatively coupled with a peripheral device. The mobile device transmits a stereo audio file to the at least one peripheral device using Bluetooth Classic.

The one or more applications 104, 204 referenced with respect to FIG. 1 and FIG. 2 run within an iOS mobile device operating system but embodiments are not so limited.

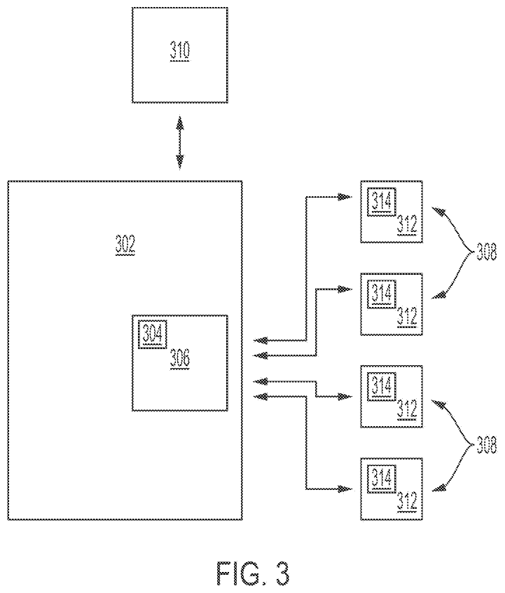

FIG. 3 shows a mobile device 302 communicatively coupled with peripheral wireless earphones 310 and sensors/haptic transducers 308 both worn by a human subject. The one or more applications 304 (running on at least one processor 306) deliver the stereo audio file to the peripheral device 310 while simultaneously delivering the mono audio file to the sensors/haptic transducers 308. Each sensor 308 includes one or more applications 314 running on one or more processors 312.

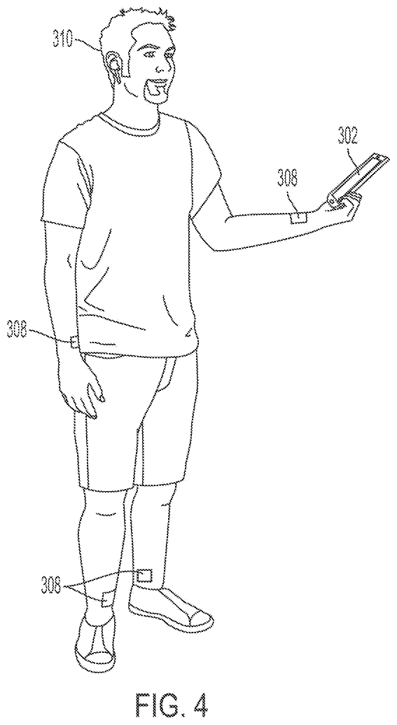

FIG. 4 shows sensors/haptic transducers 308 worn by a user, under an embodiment. The one or more applications 304 (running on at least one processor 306 of the mobile device 302) deliver the stereo audio file to the peripheral device 310 while simultaneously delivering the mono audio file to the sensors/haptic transducers 308. The sensors/haptic transducers may be placed inside of wrists slightly above where hand and wrist meet and also inside of ankle, right above ankle bone, under an embodiment.

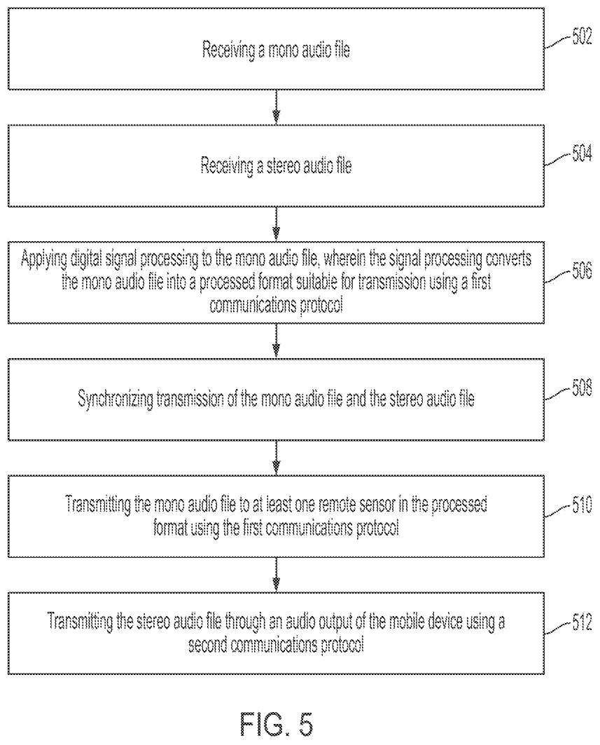

FIG. 5 shows a method for simultaneously transmitting and audio file and stereo file. The method includes 502 receiving a mono audio file. The method includes 504 receiving a stereo audio file. The method includes 506 applying digital signal processing to the mono audio file, wherein the signal processing converts the mono audio file into a processed format suitable for transmission using a first communications protocol. The method includes 508 synchronizing transmission of the mono audio file and the stereo audio file. The method includes 510 transmitting the mono audio file to at least one remote sensor in the processed format using the first communications protocol. The method includes 512 transmitting the stereo audio file through an audio output of the mobile device using a second communications protocol.

A method is described herein comprising one or more applications running on at least one processor of a mobile device for providing receiving a mono audio file, receiving a stereo audio file, applying digital signal processing to the mono audio file, wherein the signal processing converts the mono audio file into a processed format suitable for transmission using a first communications protocol, synchronizing transmission of the mono audio file and the stereo audio file, transmitting the mono audio file to at least one remote sensor in the processed format using the first communications protocol, and transmitting the stereo audio file through an audio output of the mobile device using a second communications protocol.

The one or more applications are configured to run within an iOS mobile device operating system, under an embodiment.

The first communications protocol of an embodiment comprises a Bluetooth Low Energy (BLE) protocol.

The synchronizing comprises computing a latency in transmitting the mono audio file, of under embodiment.

The latency is caused by a plurality of factors, wherein the plurality of factors includes data transmission time of the mono audio file, under an embodiment.

The plurality of factors comprises time for applying the digital signal processing, under an embodiment.

The plurality of factors includes anticipated buffering of the at least one sensor, under an embodiment.

The digital signal processing of an embodiment applies a low pass filtering of the mono audio file configured to 500 Hz to convert the mono audio file to a first format.

The first format of an embodiment comprises 44.1 kHz 192 kbps MP3.

The digital signal processing resamples and re-encodes the mono audio file in the first format to a second format, wherein the second format comprises a 1 kHz 16 bit PCM, wherein the second format comprises the processed format, under an embodiment.

The second communications protocol under an embodiment comprises Bluetooth Classic.

The at least one sensor comprises a haptic transducer, under an embodiment.

A system is comprised herein comprising one or more applications running on one or more processors of a mobile device for providing: receiving a mono audio file, receiving a stereo audio file, applying a first digital signal processing to the mono audio file, wherein the signal processing converts the mono audio file into a processed audio format suitable for transmission using a first communications protocol, synchronizing transmission of the mono audio file and the stereo audio file, transmitting the mono audio file to at least one remote sensor in the processed format using the first communications protocol, and transmitting the stereo audio file through an audio output of the mobile device using a second communications protocol. The system includes at least one application running on a processor of at least one remote sensor for providing: receiving the transmitted mono audio file, buffering the received mono audio file and playing the received mono audio file through the at least one sensor, the playing the received mono audio file comprising applying a second digital signal processing to the received mono audio file.

The one or more applications under an embodiment are configured to run within an iOS mobile device operating system.

The first communications protocol under an embodiment comprises a Bluetooth Low Energy (BLE) protocol.

The synchronizing comprises computing a latency in transmitting the mono audio file, under an embodiment.

The latency is caused by a plurality of factors, wherein the plurality of factors includes data transmission time of the mono audio file, under an embodiment.

The plurality of factors comprises time for applying the first digital signal processing, under an embodiment.

The plurality of factors includes anticipated buffering of the at least one sensor, under an embodiment.

The first digital signal processing under an embodiment applies a low pass filtering of the mono audio file configured to 500 Hz to convert the mono audio file to a first format, wherein the first format comprises 44.1 kHz 192 kbps MP3.

The digital signal processing of an embodiment resamples and re-encodes the mono audio file in the first format to a second format, wherein the second format comprises a 1 kHz 16 bit PCM, wherein the second format comprises the processed audio format.

The buffering of an embodiment comprises use of a 512 sample circular ring buffer.

The at least one sensor of an embodiment comprises a haptic transducer.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The systems and methods for delivering audio files can be a component of a single system, multiple systems, and/or geographically separate systems. The systems and methods for delivering audio files can also be a subcomponent or subsystem of a single system, multiple systems, and/or geographically separate systems. The components of systems and methods for delivering audio files can be coupled to one or more other components (not shown) of a host system or a system coupled to the host system.

One or more components of the systems and methods for delivering audio files and/or a corresponding interface, system or application to which the systems and methods for delivering audio files is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes systems and methods for delivering audio files can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods for delivering audio files and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, Systems on a Chip (SOCs) as well as application specific integrated circuits (ASICs). Some other possibilities for implementing aspects of the systems and methods for delivering audio files and corresponding systems and methods include: microcontrollers with memory (such as electronically erasable programmable read only memory (EEPROM)), embedded microprocessors, firmware, software, etc. Furthermore, aspects of the systems and methods for delivering audio files and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods for delivering audio files is not intended to be exhaustive or to limit the systems and methods to the precise forms disclosed. While specific embodiments of, and examples for, the systems and methods for delivering audio files and corresponding systems and methods are described herein for illustrative purposes, various equivalent modifications are possible within the scope of the systems and methods, as those skilled in the relevant art will recognize. The teachings of the systems and methods for delivering audio files and corresponding systems and methods provided herein can be applied to other systems and methods, not only for the systems and methods described above.

The elements and acts of the various embodiments described above can be combined to provide further embodiments. These and other changes can be made to the systems and methods for delivering audio files and corresponding systems and methods in light of the above detailed description.

1. A method comprising,
one or more applications running on at least one processor of a mobile device for providing,
receiving a mono audio file;
receiving a stereo audio file;
applying digital signal processing to the mono audio file, wherein the signal processing converts the mono audio file into a processed format suitable for transmission using a first communications protocol;
synchronizing transmission of the mono audio file and the stereo audio file;
transmitting the mono audio file to at least one remote sensor in the processed format using the first communications protocol; and
transmitting the stereo audio file through an audio output of the mobile device using a second communications protocol.

2. The method of claim 1, the one or more applications configured to run within an iOS mobile device operating system.

3. The method of claim 1, wherein the first communications protocol comprises a Bluetooth Low Energy (BLE) protocol.

4. The method of claim 1, wherein the synchronizing comprises computing a latency in transmitting the mono audio file.

5. The method of claim 4, wherein the latency is caused by a plurality of factors, wherein the plurality of factors includes data transmission time of the mono audio file.

6. The method of claim 5, wherein the plurality of factors comprises time for applying the digital signal processing.

7. The method of claim 6, wherein the plurality of factors includes anticipated buffering of the at least one sensor.

8. The method of claim 1, wherein the digital signal processing applies a low pass filtering of the mono audio file configured to 500 Hz to convert the mono audio file to a first format.

9. The method of claim 8, wherein the first format comprises 44.1 kHz 192 kbps MP3.

10. The method of claim 1, wherein the digital signal processing resamples and re-encodes the mono audio file in the first format to a second format, wherein the second format comprises a 1 kHz 16 bit PCM, wherein the second format comprises the processed format.

11. The method of claim 1, wherein the second communications protocol comprises Bluetooth Classic.

12. The method of claim 1, wherein the at least one sensor comprises a haptic transducer.

13. A system comprising,
one or more applications running on one or more processors of a mobile device for providing,
receiving a mono audio file;
receiving a stereo audio file;
applying a first digital signal processing to the mono audio file, wherein the signal processing converts the mono audio file into a processed audio format suitable for transmission using a first communications protocol;
synchronizing transmission of the mono audio file and the stereo audio file;
transmitting the mono audio file to at least one remote sensor in the processed format using the first communications protocol;
transmitting the stereo audio file through an audio output of the mobile device using a second communications protocol;
at least one application running on a processor of at least one remote sensor for providing,
receiving the transmitted mono audio file;
buffering the received mono audio file;
playing the received mono audio file through the at least one sensor, the playing the received mono audio file comprising applying a second digital signal processing to the received mono audio file.

14. The method of claim 13, the one or more applications configured to run within an iOS mobile device operating system.

15. The method of claim 13, wherein the first communications protocol comprises a Bluetooth Low Energy (BLE) protocol.

16. The method of claim 13, wherein the synchronizing comprises computing a latency in transmitting the mono audio file.

17. The method of claim 16, wherein the latency is caused by a plurality of factors, wherein the plurality of factors includes data transmission time of the mono audio file.

18. The method of claim 17, wherein the plurality of factors comprises time for applying the first digital signal processing.

19. The method of claim 18, wherein the plurality of factors includes anticipated buffering of the at least one sensor.

20. The method of claim 13, wherein the first digital signal processing applies a low pass filtering of the mono audio file configured to 500 Hz to convert the mono audio file to a first format, wherein the first format comprises 44.1 kHz 192 kbps MP3.

21. The method of claim 13, wherein the digital signal processing resamples and re-encodes the mono audio file in the first format to a second format, wherein the second format comprises a 1 kHz 16 bit PCM, wherein the second format comprises the processed audio format.

22. The method of claim 13, wherein the buffering comprises use of a 512 sample circular ring buffer.

23. The method of claim 13, wherein the at least one sensor comprises a haptic transducer.
